(19) United States
(12) Patent Application Publication
(10) Pub. No.: US 2004/0250809 A1
(43) Pub. Date: Dec. 16, 2004

(54) Grill grease collection device

(76) Inventor: Anne M. Wolf, Studio City, CA (US)

Correspondence Address: Obermayer, Rebmann, Maxwell & Hippel, LLP, One Penn Center, 19th Floor, 1617 John F. Kennedy Blvd., Philadelphia, PA, 19103, US

(21) Appl. No.: 10/461,575

(22) Filed: Jun. 13, 2003

(51) Int. Cl. A47J 37/00

(52) U.S. Cl. 126/41 R; 99/446

(57) ABSTRACT

A grill grease collection device is disclosed. The grill grease collection device includes an elongated bottom section, front and rear elongated edges, and left and right side edges. The grill grease collection device also includes front and rear elongated walls, and a left and right side wall. Combined, the elongated bottom section, front and rear elongated walls, and left and right side walls form a basin to collect grease from a grill lid. A hanger is formed into the rear elongated wall to hang the grill grease collection device from the lip of the grill. Additionally, the grill grease collection device may include a disposable liner that fits within the basin to collect grease.

### BACKGROUND OF THE INVENTION

The present invention is directed toward a method for trapping grease from a barbecue grill that drips from the rear of the grill lid onto the ground. As the grill is used, grease from the food cooking on it collects on the lid, and then drips down the back of the lid onto the ground when the lid is opened. This grease causes stains on concrete, patios, decks and the like, eventually degrading them over time. To this end, a method of collecting the grease before it drips onto the resting surface of the barbeque would be advantageous.

There are a number of patents which relate to trapping grill grease or deflecting. U.S. Pat. No. 6,463,924, for example is directed to a grease collection device for a grill for catching grease falling from an open grill cover. The device includes a bottom wall which is elongate and has a first end edge, a second end edge, a first side edge and a second side edge. A first vertical wall is attached to and extends along the length of the first side edge. A second vertical wall is attached to and extending along the length of the second side edge. A hook member is attached to and extends along a length of an upper edge of the first vertical wall. A cup member has a base wall and a peripheral wall. The peripheral wall has a tope edge defining an opening into the cup member. The top edge is attached to the second end edge such that the opening is generally within a plane of the bottom wall.

U.S. Pat. No. 6,237,472 discloses a drip collector for a grill and includes side walls, end walls, and a bottom. The drip collector is connected to a rear wall of a grill attached by one or more hooks or magnet. When the grill is in use, grease and other droppings fall from the rear wall of the grill cover into the collector. The collector is then removed for cleaning.

U.S. Pat. No. 6,247,468 is directed to a collector adapted to be mounted on the rear top edge of the base of a conventional barbecue grill to receive and collect condensed moisture running off the lower rear edge of the grill cover and has a sloped bottom wall terminating in an opening through which the fluid rains. A receptacle suspended below the opening on a hanger retains the fluid for subsequent disposal. The hanger is secured to the leg of the grill stand to anchor the collector to the grill.

However, it would be advantageous to have a grill grease collection device that is not only durable while being used, but can also be disposed of instead of having to be cleaned. This would result in a more inexpensive solution to the problem of trapping the grill grease before it drips onto the ground from the grill lid.

### OBJECTS AND SUMMARY OF THE INVENTION

It is an object of the present invention to provide a novel grill grease collection device that can easily be disposed of and is inexpensive. The grill grease collection device will mount to the back of a grill so as to trap any grease that drips from the lid of the grill when the lid is opened. Also, the grill grease collection device will easily unmount from the back of the grill so as to facilitate easy disposal of the collection device.

It is a further object of the present invention to provide a novel grill grease collection device that can be attached to the back of a grill for trapping grease that drips from the grill top, and includes a disposable liner that can be replaced by another disposable liner in the grill grease collection device.

In accordance with a first aspect of the present invention, there is provided a novel grill grease collection device. The grill grease collection device includes an elongated bottom section, having an elongated front edge, an elongated back edge, a left side edge, and a right side edge. A front elongated wall, having a bottom elongated edge, a top elongated edge, a left edge, and a right edge, mounted along the elongated front edge of the elongated bottom section at the elongated bottom edge of the front elongated wall, and extending perpendicularly outward therefrom is also included. The device further includes a rear elongated wall, having a left edge and a right edge, opposite the front elongated wall, mounted along the elongated back edge of the elongated bottom section and extending perpendicularly outward therefrom; a left wall, mounted along the left side edge of the elongated bottom section and extending perpendicularly outward therefrom, the left wall having a back edge and a front edge, the back edge of the left wall connected to the left edge of the rear elongated wall, and the front edge of the left wall connected to left edge of the front elongated wall; a right wall, mounted along the right side edge of the elongated bottom section and extending perpendicularly outward therefrom, the right wall having a back edge and a front edge, the back edge of the right wall connected to the right edge of the rear elongated wall, and the front edge of the right wall connected to right edge of the front elongated wall. The elongated bottom section, left wall, right wall, front elongated wall, and back elongated wall form a basin for trapping grill grease. The device also has a hanger, formed generally centrally into the rear elongated wall and extending upwardly perpendicularly outward from the elongated bottom section.

In accordance with another aspect of the present invention, there is disclosed a novel grill grease collection device with a liner. The grill grease collection device includes an elongated bottom section, having an elongated front edge, an elongated back edge, a left side edge, and a right side edge. A front elongated wall, having a bottom elongated edge, a top elongated edge, a left edge, and a right edge, mounted along the elongated front edge of the elongated bottom section at the elongated bottom edge of the front elongated wall, and extending perpendicularly outward therefrom is also included. The device further includes a rear elongated wall, having a left edge and a right edge, opposite the front elongated wall, mounted along the elongated back edge of the elongated bottom section and extending perpendicularly outward therefrom; a left wall, mounted along the left side edge of the elongated bottom section and extending perpendicularly outward therefrom, the left wall having a back edge and a front edge, the back edge of the left wall connected to the left edge of the rear elongated wall, and the front edge of the left wall connected to left edge of the front elongated wall; a right wall, mounted along the right side edge of the elongated bottom section and extending perpendicularly outward therefrom, the right wall having a back edge and a front edge, the back edge of the right wall connected to the right edge of the rear elongated wall, and the front edge of the right wall connected to right edge of the front elongated wall. The elongated bottom section, left wall, right wall, front elongated wall, and back elongated wall form a basin for trapping grill grease.

The device also has a hanger, formed generally centrally into the rear elongated wall and extending upwardly perpendicularly outward from the elongated bottom section. A disposable liner having a front elongated wall, rear elongated wall, elongated bottom section, left wall and right wall, fits within the basin of the grill grease collection device. In another embodiment, the liner itself comprises the entire apparatus and is disposable.

### BRIEF DESCRIPTION OF THE DRAWINGS

The foregoing summary, as well as the following detailed description of a preferred embodiment of the present invention will be better understood when read with reference to the appended drawings, wherein:

FIG. 1 is a perspective view of a grill grease collection device in accordance with a preferred embodiment of the present invention.

FIG. 2 is a front view of the grill grease collection device of FIG. 1 shown mounted on a grill.

FIG. 3 is a partial perspective view of the grill grease collection device of FIG. 1 shown mounted on a grill.

FIG. 4 is a perspective view of an alternative embodiment of a grill grease collection device in accordance with a preferred embodiment of the present invention.

### DETAILED DESCRIPTION OF THE PREFERRED EMBODIMENT

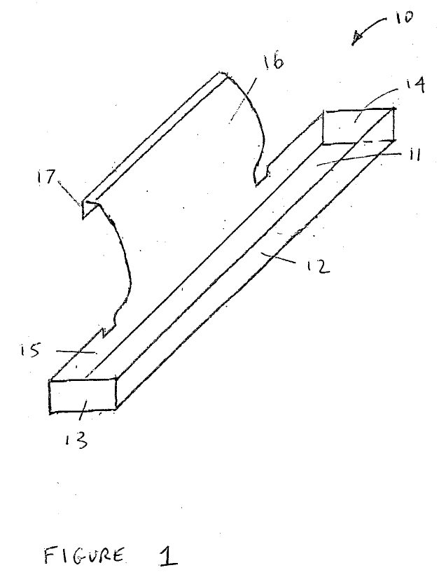

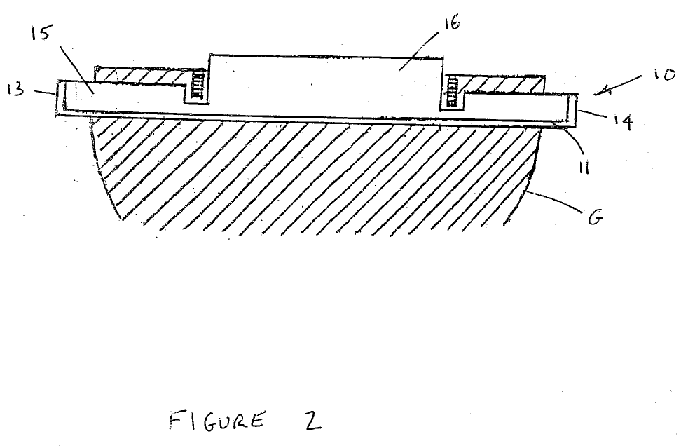

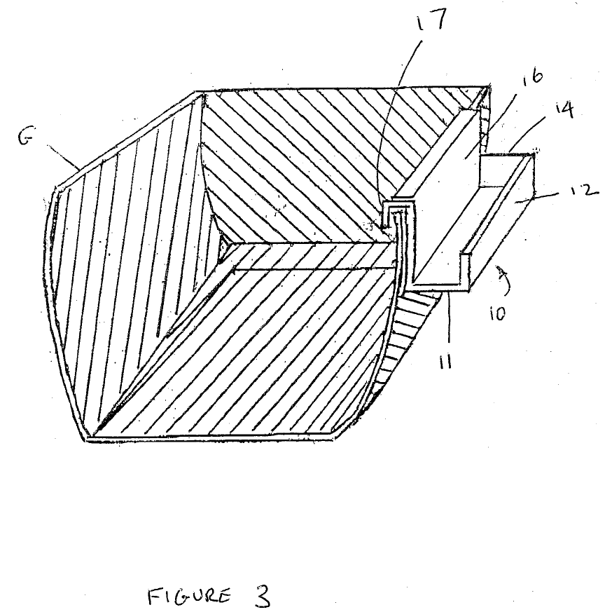

Referring now to the drawings, wherein like reference numerals refer to the same components across the several views, and in particular to FIGS. 1-3, there is shown a disposable grill grease collection device 10. The grill grease collection device 10 includes an elongated bottom section 11, a front elongated wall 12, a left side wall 13, a right side wall 14, and a rear elongated wall 15. A hanger section 16 is formed into the rear elongated wall 15.

The elongated bottom section 11 is generally rectangular in shape and includes a front elongated edge and rear elongated edge parallel to one another, and a left side edge and right side edge perpendicular to the front and rear elongated edges, but parallel to one another. The front elongated wall 12 is disposed along the front elongated edge of the elongated bottom section 11, and runs from the left side edge of the elongated bottom section 11 to the right side edge, extending generally perpendicularly outward from the elongated bottom section 11. Likewise, the rear elongated wall 15 is disposed along the rear elongated edge of the elongated bottom section 11, and runs from the left side edge of the elongated bottom section 11 to the right side edge, extending generally perpendicularly outward from the elongated bottom section 11. The left side wall 13 is disposed along the left edge of the elongated bottom section 11 and extends generally perpendicularly from the elongated bottom section 11. Similarly, the right side wall 14 is disposed along the right edge of the elongated bottom section 11 and extends generally perpendicularly from the elongated bottom section 11. The left side wall 13 and the right side wall 14 are also connected to the rear elongated section 15 and front elongated section 12. In this manner, the combination of the elongated bottom section 11, the front elongated wall 12, the left side wall 13, the right side wall 14, and the rear elongated wall 15 form a basin for trapping the grease that drips from the grill top.

In order to connect the grill grease collection device 10 to a grill ‘G’, a hanger 16 is provided. The hanger 16 is formed preferably into the rear elongated wall 15 generally centrally. The hanger 16 extends perpendicularly away from the elongated bottom section 11 and includes a near end and a distal end 17. The distal end 17 is U-shaped, and hooks onto the back lip of the grill ‘G’.

After use, the grill grease collection device 10 may be disposed. While many materials known to one of ordinary skill in the art may be used to form the grill grease collection device 10, in a preferred embodiment of the present invention, the grill grease collection device 10 is formed out of heavy duty aluminum foil. In this way, the grill grease collection device 10 is strong enough to trap the grease the drips from the lid of the grill ‘G’, but can still be made inexpensively enough so that it can be easily disposed of.

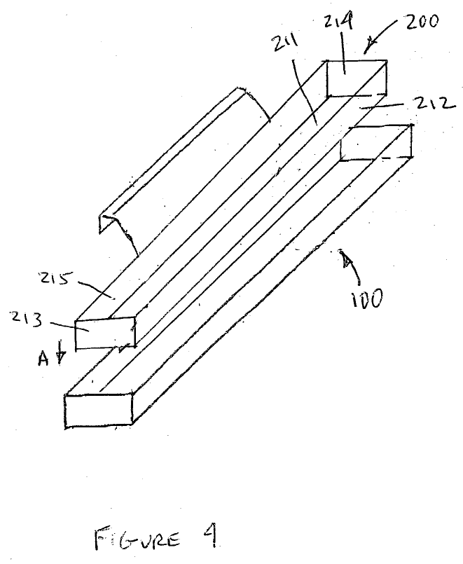

Referring now to FIG. 4, an alternative embodiment of the present invention is shown. For example, there is shown a grill grease collection device 100. The grill grease collection device 100 is formed nearly identically to the already described grill grease collection device 10, and therefore will not be described again at this point.

The grill grease collection device 100 also includes in this embodiment a liner 200. The liner 200 includes an elongated bottom section 211, a front elongated wall 212, a left side wall 213, a right side wall 214, and a rear elongated wall 215.

The elongated bottom section 211 is generally rectangular in shape and includes a front elongated edge and rear elongated edge parallel to one another, and a left side edge and right side edge perpendicular to the front and rear elongated edges, but parallel to one another. The front elongated wall 212 is disposed along the front elongated edge of the elongated bottom section 211, and runs from the left side edge of the elongated bottom section 211 to the right side edge, extending generally perpendicularly outward from the elongated bottom section 211. Likewise, the rear elongated wall 215 is disposed along the rear elongated edge of the elongated bottom section 211, and runs from the left side edge of the elongated bottom section 211 to the right side edge, extending generally perpendicularly outward from the elongated bottom section 211. The left side wall 213 is disposed along the left edge of the elongated bottom section 211 and extends generally perpendicularly from the elongated bottom section 211. Similarly, the right side wall 214 is disposed along the right edge of the elongated bottom section 211 and extends generally perpendicularly from the elongated bottom section 211. The left side wall 213 and the right side wall 214 are also connected to the rear elongated section 215 and front elongated section 212. In this manner, the combination of the elongated bottom section 211, the front elongated wall 212, the left side wall 213, the right side wall 214, and the rear elongated wall 215 form a basin for trapping the grease that drips from the grill top.

The liner 200 is formed slightly smaller than the inside dimensions of the grill grease collection device 100, so as to allow ease of inserting the liner 200 into the grill grease collection device 100 along the direction of arrow ‘A’. Likewise, the liner 200 may be removed by lifting it out of the grill grease collection device 100 along the opposite direction of arrow ‘A’.

Since the grill grease collection device 100 in this alternative embodiment of the present invention is of a more permanent nature, it may be formed of a suitable material, such as aluminum or cast iron, or any other material known to one of ordinary skill in the art. Likewise, the liner 200 may be formed of any material known to one of ordinary skill in the art, but in a preferred embodiment the liner 200 is formed of a heavy duty aluminum foil.

In view of the foregoing disclosure, some of the advantages of the present invention can be seen. For instance, a disposable grill grease collection device is disclosed. This collection device allows for a more inexpensive way of collecting grease from the lid of a grill and provides ease of disposal of the collection device.

While the preferred embodiments of the present invention have been described and illustrated, modifications may be made by one of ordinary skill in the art without departing from the scope of the invention as defined in the appended claims.

What is claimed is:

1. A disposable grill grease collection device comprising:
an elongated bottom section, having an elongated front edge, an elongated back edge, a left side edge, and a right side edge;
a front elongated wall, having a bottom elongated edge, a top elongated edge, a left edge, and a right edge, mounted along the elongated front edge of the elongated bottom section at the elongated bottom edge of the front elongated wall, and extending perpendicularly outward therefrom;
a rear elongated wall, having a left edge and a right edge, opposite the front elongated wall, mounted along the elongated back edge of the elongated bottom section and extending perpendicularly outward therefrom;
a left wall, mounted along the left side edge of the elongated bottom section and extending perpendicularly outward therefrom, the left wall having a back edge and a front edge, said back edge of the left wall connected to the left edge of the rear elongated wall, and said front edge of the left wall connected to left edge of the front elongated wall;
a right wall, mounted along the right side edge of the elongated bottom section and extending perpendicularly outward therefrom, the right wall having a back edge and a front edge, said back edge of the right wall connected to the right edge of the rear elongated wall, and said front edge of the right wall connected to right edge of the front elongated wall;
whereby the elongated bottom section, left wall, right wall, front elongated wall, and back elongated wall form a basin for trapping grill grease; and
a hanger, formed generally centrally into the rear elongated wall and extending upwardly perpendicularly outward from the elongated bottom section.

2. The disposable grill grease collection device of claim 1, wherein the hanger further comprises a near end and a distal end to the elongated bottom section of the disposable grill grease collection device.

3. The disposable grill grease collection device of claim 2, wherein the distal end of the hanger is U-shaped so as to hook onto the back of a grill.

4. The disposable grill grease collection device of claim 1, further comprising a disposable liner.

5. The disposable grill grease collection device of claim 4, wherein the disposable liner fits within the basin of the disposable grill grease collection device.

6. The disposable grill grease collection device of claim 4, wherein the disposable liner comprises a front elongated wall, rear elongated wall, elongated bottom section, left wall and right wall.

7. The disposable grill grease collection device of claim 6, wherein the disposable liner fits within the basin of the disposable grill grease collection device.

8. A grill grease collection device comprising:
an elongated bottom section, having an elongated front edge, an elongated back edge, a left side edge, and a right side edge;
a front elongated wall, having a bottom elongated edge, a top elongated edge, a left edge, and a right edge, mounted along the elongated front edge of the elongated bottom section at the elongated bottom edge of the front elongated wall, and extending perpendicularly outward therefrom;
a rear elongated wall, having a left edge and a right edge, opposite the front elongated wall, mounted along the elongated back edge of the elongated bottom section and extending perpendicularly outward therefrom;
a left wall, mounted along the left side edge of the elongated bottom section and extending perpendicularly outward therefrom, the left wall having a back edge and a front edge, said back edge of the left wall connected to the left edge of the rear elongated wall, and said front edge of the left wall connected to left edge of the front elongated wall;
a right wall, mounted along the right side edge of the elongated bottom section and extending perpendicularly outward therefrom, the right wall having a back edge and a front edge, said back edge of the right wall connected to the right edge of the rear elongated wall, and said front edge of the right wall connected to right edge of the front elongated wall;
whereby the elongated bottom section, left wall, right wall, front elongated wall, and back elongated wall form a basin for trapping grill grease;
a hanger, formed generally centrally into the rear elongated wall and extending upwardly perpendicularly outward from the elongated bottom section; and
a disposable liner, said disposable liner comprising a front elongated wall, rear elongated wall, elongated bottom section, left wall and right wall, and fits within the basin of the disposable grill grease collection device.
